(19) United States
(12) Patent Application Publication
(10) Pub. No.: US 2025/0018900 A1
(43) Pub. Date: Jan. 16, 2025

(54) VEHICLE SENSOR CLEANING SYSTEM INCLUDING AN AIR SUPPLY MODULE INTEGRATED WITH A WASHING LIQUID SUPPLY MODULE

(71) Applicants: HYUNDAI MOTOR COMPANY, Seoul (KR); KIA CORPORATION, Seoul (KR); HYUNDAM INDUSTRIAL CO., LTD., Asan-si (KR); DONG HEE INDUSTRIAL CO., LTD., Ulsan (KR)

(72) Inventors: Seong Cheol Cho, Seoul (KR); Yoon Geun Cho, Daegu (KR); Sung Won Lee, Hwaseong-si (KR); Je Yeon Kim, Hwaseong-si (KR); Chul Young Choi, Suwon-si (KR); Hyun Su Yoo, Cheonan-si (KR); Kyun Bum Park, Hwaseong-si (KR); Kun Su Hwang, Incheon (KR); Bu Hyeon Cho, Asan-si (KR); Chan Yo Jeon, Daejeon (KR); Seung Hwan Lee, Asan-si (KR)

(73) Assignees: HYUNDAI MOTOR COMPANY, Seoul (KR); KIA CORPORATION, Seoul (KR); HYUNDAM INDUSTRIAL CO., LTD., Asan-si (KR); DONG HEE INDUSTRIAL CO., LTD., Ulsan (KR)

(21) Appl. No.: 18/520,053

(22) Filed: Nov. 27, 2023

(30) Foreign Application Priority Data
Jul. 12, 2023 (KR) 10-2023-0090434

(51) Int. Cl. B60S 1/56; B60S 1/48; B60S 1/54

(52) U.S. Cl. CPC B60S 1/56; B60S 1/481; B60S 1/54

(57) ABSTRACT

An integrated cleaning module of a vehicle sensor includes a washing liquid supply module configured to supply cleaning liquid; and an air supply module connected to the washing liquid supply module and configured to supply air. The air supply module includes a compressor configured to generate compressed air; an air tank in which the compressed air generated by the compressor is stored; and an integrated dispenser configured to be in fluid connection with the washing liquid supply module and the air tank. The integrated dispenser is configured to distribute the cleaning liquid and the compressed air.

### CROSS-REFERENCE TO RELATED APPLICATIONS

This application claims the benefit of and the priority to Korean Patent Application No. 10-2023-0090434, filed on Jul. 12, 2023, the disclosure of which is incorporated herein by reference in its entirety.

### TECHNICAL FIELD

The present disclosure relates to a sensor cleaning system which may clean a sensor disposed in a vehicle. More particularly, the present disclosure relates to a sensor cleaning system including an integrated cleaning module in which an air supply module is integrated with a washing liquid supply module.

### BACKGROUND

A vehicle may be equipped with various types of sensors (a camera, a radar, a lidar, or the like) to increase safety and driving convenience for a driver. A vehicle sensor may not operate normally when foreign substances are present on the surface of the sensor.

Particularly, in recent years, research into and development of an advanced driver assistance system (ADAS) and an autonomous vehicle have been actively conducted, and to implement this, a light detection and ranging sensor (LiDAR) may be mounted on a vehicle. However, in the case that the sensor becomes contaminated with foreign substances and fails to operate correctly, the safety of vehicle operations may be compromised. Accordingly, it may be necessary to clean the sensor.

The statements in this section merely provide background information related to the present disclosure and may not constitute prior art.

### SUMMARY

As a method of cleaning the sensor, a system for spraying high-pressure fluid (air and cleaning liquid) using a nozzle to clean the sensors mounted on the vehicle may be applied. Nonetheless, a system for spraying air and a system for spraying cleaning liquid may need to be separately configured. As a result, the system may have a great deal of components, increasing the complexity of assembly and A/S may not be easily performed.

An aspect of the present disclosure is to provide, by integrating a cleaning system for spraying air and a cleaning system for spraying cleaning liquid into a module, a vehicle sensor cleaning system in which an overall system may be simplified and packaged.

According to an embodiment of the present disclosure, an integrated cleaning module of a vehicle sensor includes a washing liquid supply module configured to supply cleaning liquid, and an air supply module connected to the washing liquid supply module and configured to supply air. The air supply module includes a compressor configured to generate compressed air, and an air tank in which the compressed air generated by the compressor is stored. The air supply module also includes an integrated dispenser configured to be in fluid connection with the washing liquid supply module and the air tank. Additionally, the integrated dispenser is configured to distribute the cleaning liquid and the compressed air.

The washing liquid supply module may include a cleaning liquid tank configured to store the cleaning liquid and a pump configured to transfer the cleaning liquid stored in the cleaning liquid tank to the integrated dispenser. The integrated dispenser may be configured to be in fluid connection with the pump and a pipe.

The integrated dispenser may include an air flow path through which the compressed air supplied from the air tank moves and a cleaning liquid flow path through which the cleaning liquid supplied from the pump of the washing liquid supply module moves. The air flow path and the cleaning liquid flow path may be separated such that movement of the fluid is blocked.

The integrated dispenser may include an air inlet port and at least one air distribution port communicating with the air flow path. The air inlet port may be connected to the air tank through a pipe.

The integrated dispenser may include a cleaning liquid inlet port and at least one cleaning liquid distribution port communicating with the cleaning liquid flow path. The cleaning liquid inlet port may be connected to the pump through a pipe.

The integrated dispenser may include a body in which at least one solenoid valve is disposed and an upper cover coupled to an upper portion of the body. The air flow path, the air inlet port, and the at least one air distribution port may be formed on one side of the upper cover. The cleaning liquid flow path, the cleaning liquid inlet port, and the at least one cleaning liquid distribution port may be formed on another side of the upper cover.

The at least one air distribution port includes a plurality of air distribution ports and the at least one cleaning liquid distribution port includes a plurality of cleaning liquid distribution ports. The at least one solenoid valve includes a plurality of solenoid valves that may be provided to correspond to the number of the air distribution ports, the number of the cleaning liquid distribution ports, and positions of the air distribution ports and the cleaning liquid distribution ports.

The integrated cleaning module may further include a support plate on which the air supply module and the washing liquid supply module are mounted. The air supply module and the washing liquid supply module are integrally assembled to the support plate.

According to an embodiment of the present disclosure, a sensor cleaning system configured to clean a sensor of a vehicle includes an integrated cleaning module including a washing liquid supply module configured to supply cleaning liquid and a first air supply module connected to the washing liquid supply module and configured to supply air. The system also includes a second air supply module connected to the washing liquid supply module through a first pipe, and a third air supply module connected to the washing liquid supply module through a second pipe. The second air supply module and the third air supply module include the same components as those of the first air supply module.

The first air supply module may include a first compressor configured to generate compressed air, and a first air tank in which the compressed air generated by the compressor is stored. The first air supply module may further include a first integrated dispenser connected to the washing liquid supply module and the first air tank, and configured to distribute the cleaning liquid and the compressed air.

The second air supply module may include a second compressor, a second air tank, and a second integrated dispenser. The third air supply module may include a third compressor, a third air tank, and a third integrated dispenser. The first pipe may be connected to the second integrated dispenser, and the second pipe may be connected to the third integrated dispenser.

The second integrated dispenser may be configured to receive the cleaning liquid from the washing liquid supply module of the integrated cleaning module through the first pipe. The third integrated dispenser may be configured to receive the cleaning liquid from the washing liquid supply module of the integrated cleaning module through the second pipe.

The washing liquid supply module may include a cleaning liquid tank configured to store the cleaning liquid and a pump configured to move the cleaning liquid stored in the cleaning liquid tank. A first cleaning liquid discharge port and a second cleaning liquid discharge port through which the cleaning liquid is discharged may be formed in the pump. The first integrated dispenser may be connected to the first cleaning liquid discharge port through a pipe, and the first pipe and the second pipe may be connected to the second cleaning liquid discharge port.

Each of the first integrated dispenser, the second integrated dispenser, and the third integrated dispenser may include an air inlet port and a plurality of air distribution ports. The air inlet port may be connected to the air tank. Additionally, the plurality of air distribution ports may be connected to a plurality of air nozzles disposed on at least one sensor and configured to spray the compressed air.

Each of the first integrated dispenser, the second integrated dispenser, and the third integrated dispenser may include a cleaning liquid inlet port and a plurality of cleaning liquid distribution ports. The cleaning liquid inlet port may be connected to the washing liquid supply module. Additionally, the plurality of cleaning liquid distribution ports may be connected to a plurality of cleaning liquid nozzles disposed on the at least one sensor and configured to spray the cleaning liquid.

The first integrated dispenser, the second integrated dispenser, and the third integrated dispenser may further include a first dispenser control unit, a second dispenser control unit, and a third dispenser control unit, respectively. The first dispenser control unit, the second dispenser control unit, and the third dispenser control unit may be configured to control spraying of the compressed air and the cleaning liquid based on a control signal received from an integrated control unit of the vehicle.

The first integrated dispenser, the second integrated dispenser, and the third integrated dispenser may include the plurality of solenoid valves disposed therein. The first dispenser control unit, the second dispenser control unit, and the third dispenser control unit may be configured to control opening or closing of at least a portion of the plurality of solenoid valves based on the control signal.

The integrated cleaning module, the second air supply module, and the third air supply module may be spaced apart from each other in different positions in the vehicle.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a perspective view illustrating an integrated cleaning module according to an embodiment of the present disclosure;

FIG. 2 is an exploded perspective view illustrating an integrated cleaning module according to an embodiment of the present disclosure;

FIG. 3 is a diagram illustrating a vehicle sensor cleaning system according to an embodiment of the present disclosure;

FIG. 4 is a diagram illustrating a configuration of a vehicle sensor cleaning system according to an embodiment of the present disclosure; and

FIG. 5 is a diagram illustrating an operation in which control of an integrated dispenser is performed in a vehicle sensor cleaning system according to an embodiment of the present disclosure.

### DETAILED DESCRIPTION

Hereinafter, embodiments of the present disclosure are described with reference to the attached drawings.

Various embodiments are described with reference to accompanying drawings. However, this may not necessarily limit the scope of the embodiments to a specific embodiment form. Instead, modifications, equivalents, and replacements included in the disclosed concept and technical scope of the description may be employed. Throughout the specification, similar reference numerals are used for similar elements.

In the embodiments, the terms “first,” “second,” and the like may be used to distinguish one element from the other, and may not limit a sequence and/or an importance, or others, in relation to the elements. In some cases, a first element may be referred to as a second element, and similarly, a second element may be referred to as a first element without departing from the scope of the present disclosure.

The embodiments may be implemented in various ways, and are not limited to the embodiments described herein. An expression used in the singular encompasses the expression of the plural, unless it has a clearly different meaning in the context. The terms, “include,” “comprise,” “is configured to,” or the like, of the description are used to indicate the presence of features, numbers, steps, operations, elements, parts, or combinations thereof. These terms do not exclude the possibilities of combinations or the addition of one or more features, numbers, steps, operations, elements, parts, or combinations thereof.

Unless otherwise defined, all terms used herein, including technical or scientific terms, have the same meanings as those having ordinary skill in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

When a component, device, element, or the like of the present disclosure is described as having a purpose or performing an operation, function, or the like, the component, device, or element should be considered herein as being “configured to” meet that purpose or perform that operation or function.

In various embodiments, a vehicle may refer to a variety of vehicles for transporting people, animals, and objects, from a starting point to a destination. The vehicles are not limited to those driving on roads or tracks.

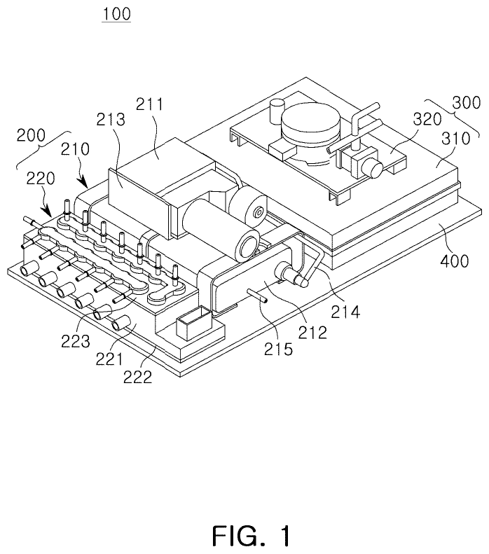

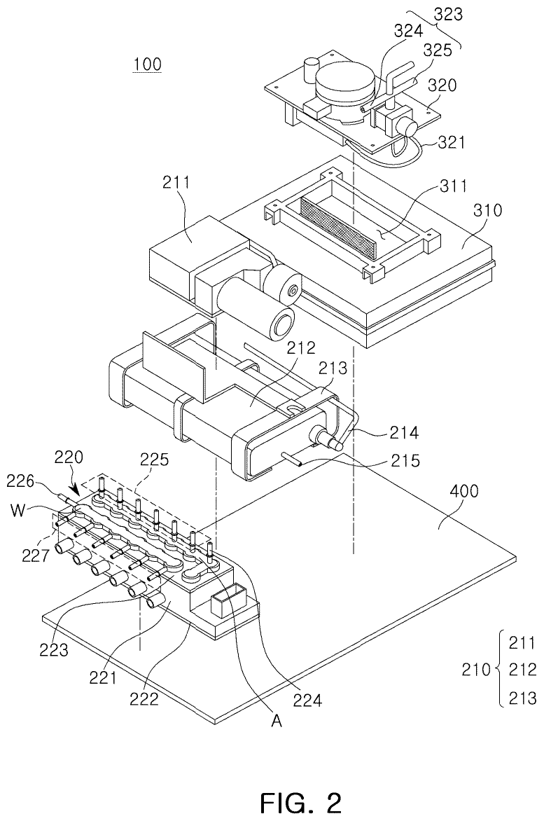

FIG. 1 is a perspective diagram illustrating an integrated cleaning module according to an embodiment. FIG. 2 is an exploded perspective diagram illustrating an integrated cleaning module according to an embodiment.

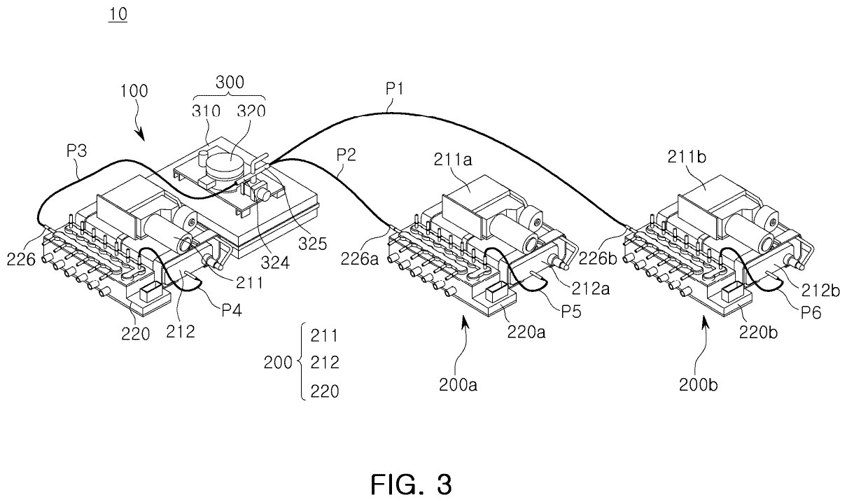

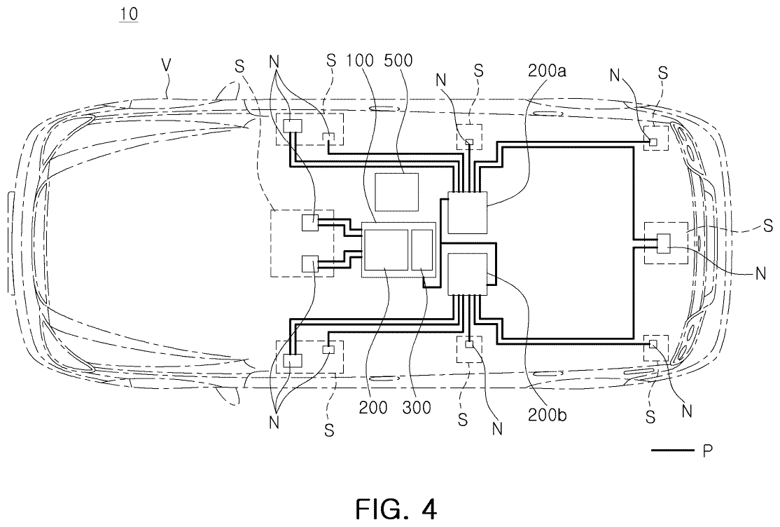

Referring to FIGS. 1 and 2, an integrated cleaning module 100 according to an embodiment may include an air supply module 200, a washing liquid supply module 300, and a support plate 400. For example, the integrated cleaning module 100 may have a structure in which an air supply module 200 and a washing liquid supply module 300 may be integrated (or modularized) and may form a module or an assembly. The integrated cleaning module 100 may be installed in the vehicle, and may spray or eject at least one of air and cleaning liquid through pipes (e.g., a plurality of pipes P in FIG. 4) to clean (wash) the sensors. The sensor cleaning system 10 of the vehicle including the integrated cleaning module 100 is described in greater detail with reference to FIGS. 3 and 4 below.

The air supply module 200 may include a compressor (or air compressor) 211, an air tank 212, a bracket 213, and an integrated dispenser 220. The air supply module 200 of the integrated cleaning module 100 according to an embodiment may be provided in an integrated structure such that the compressed air supply unit 210 and the integrated dispenser 220 including the compressor 211 and the air tank 212 may be included in a module or an assembly. For example, a compressor 211, an air tank 212, and a bracket 213 may be included in a compressed air supply unit 210 for generating and storing compressed air and supplying the air to the integrated dispenser 220.

The compressor 211 may compress air and provide compressed air. In other words, the compressor 211 may generate compressed air and may supply the generated compressed air to the air tank 212. The compressor 211 may include one or more motors. In various embodiments, the compressor 211 may adjust the degree of compression of the compressed air stored in the air tank 212.

The air tank 212 may store the compressed air generated by the compressor 211 therein. The compressor 211 and the air tank 212 may be connected through an air pipe 214 to allow air to move. For example, the compressed air generated by the compressor 211 may move and may be filled into the air tank 212 through the air pipe 214. The air stored in the air tank 212 may be distributed through the integrated dispenser 220, may be sprayed toward various sensors included in the vehicle, and may be used for cleaning. The air tank 212 may include an air discharge port 215 connected to the integrated dispenser 220 (e.g., air inlet port 224) and a pipe (e.g., pipe P4 in FIG. 3) such that compressed air stored therein may be discharged (or supplied) to the integrated dispenser 220.

The bracket 213 may be configured to mount or fix the compressor 211 to the air tank 212. The bracket 213 may be coupled to the air tank 212 to cover at least a portion of an external side surface of the air tank 212. For example, the bracket 213 may be coupled to the air tank 212, and the compressor 211 may be coupled to an upper portion of the bracket 213. In various embodiments, the air supply module 200 may be provided in a structure in which the bracket 213 may not be provided and the compressor 211 and the air tank 212 may be directly coupled to each other.

The integrated dispenser 220 may distribute the compressed air supplied from the air tank 212 and the cleaning liquid supplied from the pump 320 to a plurality of nozzles (e.g., a plurality of nozzles N in FIG. 4) disposed in a plurality of sensors, respectively. The integrated dispenser 220 may perform both the distribution of compressed air and the distribution of cleaning liquid. For example, the integrated dispenser 220 may distribute compressed air and/or cleaning liquid to a plurality of nozzles connected to the integrated dispenser 220, and the compressed air and/or cleaning liquid may be sprayed or ejected to the plurality of sensors through the plurality of nozzles. In various embodiments, the integrated dispenser 220 may be coupled to the bracket 213. Accordingly, the integrated dispenser 220 and the compressed air supply unit 210 (e.g., compressor 211 and air tank 212) may be included in a module or an assembly. In an embodiment, by integrating a distributor for distributing compressed air and a distributor for distributing cleaning liquid into a distributor, the cleaning liquid supplied from the washing liquid supply module 300 may be distributed through the integrated dispenser 220 included in the air supply module 200 without a distributor. As a result, the configuration of the cleaning module 100 and the system 10 of the vehicle may be simplified.

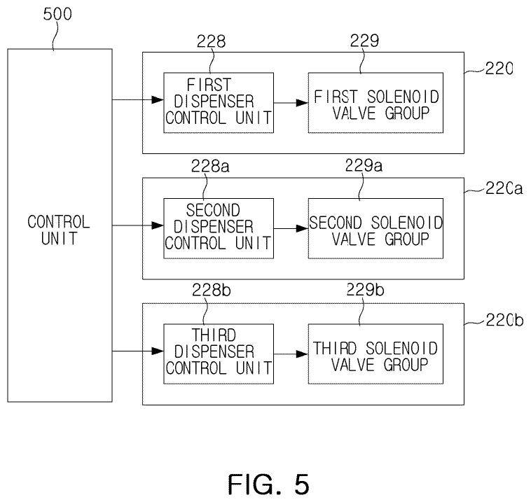

The integrated dispenser 220 may include a body 221, a lower cover 222, and an upper cover 223. The lower cover 222 may be coupled to a lower portion of the body 221, and the upper cover 223 may be coupled to an upper portion of the body 221. Although not illustrated, the integrated dispenser 220 according to an embodiment may include a substrate (e.g., a printed circuit substrate (PCB)) accommodated in the body 221, a plurality of solenoid valves (e.g., solenoid valve groups 229, 229a, and 229b illustrated in FIG. 5) and a sealing member. For example, the substrate may be disposed in the lower cover 222 and accommodated in the body 221, and a control module (e.g., dispenser control units 228, 228a, and 228b illustrated in FIG. 5) for controlling the opening/closing (or turning on/turning off) of a plurality of solenoid valves may be disposed on the substrate.

In the upper cover 223, an air flow path A and a cleaning liquid flow path W may be separated from each other. For example, the air flow path A and the cleaning liquid flow path W may be separated or distinct, such that fluid movement therebetween may be closed.

An air inlet port 224 and a plurality of air distribution ports 225 connected to the air flow path A may be formed externally on the upper cover 223. The air flow path A, the air inlet port 224, and the plurality of air distribution ports 225 may form a path through which compressed air supplied from the air tank 212 flows (e.g., moves). For example, the air inlet port 224 may be connected to the air discharge port 215 of the air tank 212 through a pipe (e.g., pipe P4 in FIG. 3). The compressed air flowing into the air inlet port 224 may move to the plurality of air distribution ports 225 through the air flow path A and may be distributed. The plurality of solenoid valves accommodated in the body 221 may include a plurality of air distribution valves provided to correspond to the number of the plurality of air distribution ports 225 and the position thereof. The spraying of compressed air may be adjusted by controlling the on/off operation of at least a portion of the plurality of air distribution valves, all of which is managed by the control module. For example, the movement of air between the air flow path A and the plurality of air distribution ports 225 may be allowed or closed by turning the plurality of air distribution valves on and off.

The exterior of the upper cover 223 may include a cleaning liquid inlet port 226 and a plurality of cleaning liquid distribution ports 227 connected to the cleaning liquid flow path W. The cleaning liquid flow path W, the cleaning liquid inlet port 226, and the plurality of cleaning liquid distribution ports 227 may form a path along which the cleaning liquid supplied from the cleaning liquid tank 310 flows (e.g., moves). For example, the cleaning liquid inlet port 226 may be connected to the cleaning liquid discharge port 323 of the pump 320 through a pipe (e.g., a pipe P3 in FIG. 3). The cleaning liquid flowing into the cleaning liquid inlet port 226 may flow to a plurality of cleaning liquid distribution ports 227 through the cleaning liquid flow path W and may be distributed. The plurality of solenoid valves accommodated in the body 221 may include a plurality of cleaning liquid distribution valves provided to correspond to the number of the plurality of cleaning liquid distribution ports 227 and the position thereof. By controlling at least a portion of the plurality of cleaning liquid distribution valves on and off by the control module, the spraying of cleaning liquid may be controlled. For example, movement of the cleaning liquid between the cleaning liquid flow path W and the plurality of cleaning liquid distribution ports 227 may be allowed or closed by turning the plurality of cleaning liquid distribution valves on and off.

The washing liquid supply module 300 may include a cleaning liquid tank 310 and a pump 320 connected to the cleaning liquid tank 310. For example, the pump 320 may be coupled to an upper portion of the cleaning liquid tank 310 and at least a portion may be received in the cleaning liquid tank 310.

The cleaning liquid tank 310 may store cleaning liquid (or washer fluid) therein. The cleaning liquid may be formed using various types of liquids. The pump 320 may move the cleaning liquid stored in the cleaning liquid tank 310 to the integrated dispenser 220. The pump 320 may include a hose 321 extending into an inner space of the cleaning liquid tank 310 filled with cleaning liquid. The cleaning liquid stored in the cleaning liquid tank 310 may be supplied to the integrated dispenser 220 through the pump 320, may be distributed through the integrated dispenser 220, may be sprayed toward various sensors included in the vehicle, and may be used for cleaning.

The pump 320 and the integrated dispenser 220 may be connected through a pipe to enable movement of the cleaning liquid. The pump 320 may include a cleaning liquid discharge port 323 connected to an integrated dispenser 220 (e.g., cleaning liquid inlet port 226) through a pipe (e.g., pipe P3 in FIG. 3) to allow the cleaning liquid transferred (or pumped) from the cleaning liquid tank 310 to be discharged (or supplied) to the integrated dispenser 220. As illustrated, two cleaning liquid discharge ports (e.g., a first cleaning liquid discharge port 324 and a second cleaning liquid discharge port 325) of the cleaning liquid discharge port 323 may be included. However, the embodiment thereof is not limited thereto, and in various embodiments, one or three or more cleaning liquid discharge ports 323 may be provided.

The support plate 400 may support the air supply module 200 and the washing liquid supply module 300. For example, an air supply module 200 and a washing liquid supply module 300 may be mounted on an upper portion of the support plate 400. The air supply module 200 and the washing liquid supply module 300 may be mounted on the support plate 400, thereby being integrally assembled (or modularized). As illustrated, the integrated dispenser 220, the compressed air supply unit 210 (the compressor 211 and the air tank 212), and the washing liquid supply module 300 may be disposed in order on the seating surface of the support plate 400 in a length direction of the support plate 400. However, the example embodiment thereof is not limited thereto. For instance, each of the integrated dispenser 220, the air tank 212 (or bracket 213,) and the cleaning liquid tank 310 may be coupled to the support plate 400. Also, each of the bracket 213 and the cleaning liquid tank 310 may be coupled to the support plate 400, and the integrated dispenser 220 may be coupled to the bracket 213. In various embodiments, the support plate 400 may not be provided.

FIG. 3 is a diagram illustrating a vehicle sensor cleaning system according to an embodiment. FIG. 4 is a diagram illustrating a configuration of a vehicle sensor cleaning system according to an embodiment.

FIG. 3 illustrates a pipe connection structure between modules in a vehicle sensor cleaning system 10 including the integrated cleaning module 100 illustrated in FIGS. 1 and 2. FIG. 4 illustrates a vehicle V to which the vehicle sensor cleaning system 10 including the integrated cleaning module 100 illustrated in FIGS. 1 and 2 is applied. Hereinafter, in describing FIGS. 3 and 4, FIGS. 1 and 2 will also be referred to.

Referring to FIGS. 3 and 4, a vehicle sensor cleaning system 10 according to an embodiment may include an integrated cleaning module 100, a second air supply module 200a, and a third air supply module 200b. The integrated cleaning module 100 may include a first air supply module 200 and a washing liquid supply module 300. The washing liquid supply module 300 may include a cleaning liquid tank 310 and a pump 320.

The first air supply module 200 may include a first compressor 211, a first air tank 212, and a first integrated dispenser 220. The cleaning liquid inlet port 226 of the first integrated dispenser 220 may be connected to the washing liquid supply module 300 (e.g., the first cleaning liquid discharge port 324 of the pump 320) through the pipe P3. The air inlet port 224 of the first integrated dispenser 220 may be connected to the air discharge port 215 of the first air tank 212 through a pipe P4.

The first air supply module 200 of the integrated cleaning module 100, as illustrated in FIGS. 3 and 4, may be configured the same as the air supply module 200 (e.g., the compressor 211, the air tank 212, and the bracket 213 in FIGS. 1 and 2) of the integrated cleaning module 100 described with reference to FIGS. 1 and 2. However, the first air supply module 200 is referred to as the first air supply module 200 to be distinct from the second air supply module 200a and the third air supply module 200b in the description of FIGS. 3 and 4. Since the detailed description of the air supply module 200 and the washing liquid supply module 300 has been described above with reference to FIGS. 1 and 2, overlapping descriptions are not provided.

The second air supply module 200a and the third air supply module 200b may be configured the same as the first air supply module 200. For example, the second air supply module 200a may include a second compressor 211a, a second air tank 212a, and a second integrated dispenser 220a. A third air supply module 200b may include a third compressor 211b, a third air tank 212b, and a third integrated dispenser 220b. Also, for example, the air inlet port 224 of the second integrated dispenser 220a may be connected to the air discharge port 215 of the second air tank 212a through pipe P5. The air inlet port 224 of the third integrated dispenser 220b may be connected to the air discharge port 215 of the third air tank 212b through pipe P6.

The second air supply module 200a and the third air supply module 200b may receive cleaning liquid from the washing liquid supply module 300 of the integrated cleaning module 100. The second integrated dispenser 220a of the second air supply module 200a and the third integrated dispenser 220b of the third air supply module 200b may be connected to the washing liquid supply module 300 through the cleaning liquid pipes P1 and P2, respectively. For example, the cleaning liquid inlet port 226a of the second integrated dispenser 220a and the second cleaning liquid discharge port 325 of the pump 320 may be connected to the first cleaning liquid pipe P1. The cleaning liquid inlet port 226b of the third integrated dispenser 220b and the second cleaning liquid discharge port 325 of the pump 320 may be connected to the second cleaning liquid pipe P2. The first cleaning liquid pipe P1 and the second cleaning liquid pipe P2 may be formed as separate pipes or may be branched from the same pipe.

As illustrated in FIG. 4, the first integrated dispenser 220 of the first air supply module 200, the second integrated dispenser 220a of the second air supply module 200a, and the third integrated dispenser 220b of the third air supply module 200b may be connected to a plurality of nozzles N disposed adjacently to a plurality of sensors S using a plurality of pipes (or hoses) P, respectively. For example, a box indicated by a dotted line in FIG. 4 may indicate a predetermined region in which a plurality of sensors S is disposed. Additionally, a plurality of nozzles N connected to the integrated dispensers 220, 220a, and 220b through a plurality of pipes P may be disposed in a region in which a plurality of sensors S is mounted, respectively. and the nozzles N may eject air and/or cleaning liquid to the plurality of sensors S. The plurality of air distribution ports 225 of the first integrated dispenser 220, the second integrated dispenser 220a, and the third integrated dispenser 220b may be respectively connected to the plurality of nozzles (e.g., air spraying nozzles) N through the plurality of pipes P. The plurality of cleaning liquid distribution ports 227 of the first integrated dispenser 220, the second integrated dispenser 220a and the third integrated dispenser 220b may be respectively connected to the plurality of nozzles (e.g., cleaning liquid spraying nozzles) N through the plurality of pipes P. For example, the pipes P and the nozzles N connected to the air distribution ports 225 of the integrated dispensers 220, 220a, and 220b may be separated or distinct from the pipes P and the nozzles N connected to the cleaning liquid distribution ports 227 of the integrated dispensers 220, 220a, and 220b.

The sensor cleaning system 10 may be connected to the integrated control unit 500. The integrated control unit 500 may control the integrated cleaning module 100, the second air supply module 200a, and the third air supply module 200b. The integrated control unit 500 may be electrically connected to the first air supply module 200, the second air supply module 200a, and the third air supply module 200b. Additionally, the integrated control unit 500 may be electrically connected to the washing liquid supply module 300. The integrated control unit 500 may control the spraying of the air and cleaning liquid. The integrated control unit 500 may control the first integrated dispenser 220 of the first air supply module 200, the second integrated dispenser 220a of the second air supply module 200a, and the third integrated dispenser 220b of the third air supply module 200b, such that air and/or cleaning liquid may be sprayed to the plurality of sensor S simultaneously or sequentially, or air and/or cleaning liquid may be sprayed only to a specific sensor which needs to be cleaned. For example, the integrated control unit 500 may sense (or detect) a sensor S requiring cleaning among the plurality of sensor S. The integrated control unit 500 may then control the sensor cleaning system 10 to spray air and/or cleaning liquid to the sensor. For example, the integrated control unit 500 may be implemented as a vehicle control unit (VCU) for controlling the overall system of the vehicle. However, the embodiment thereof is not limited thereto, and the integrated control unit 500 may be configured as a component separate from the vehicle control unit.

By combining or individually applying two types of modules (e.g., air supply module 200 and washing liquid supply module 300), the sensor cleaning system 10 according to an embodiment may be implemented in a structure in which three modules, for example, the integrated cleaning module 100 (e.g., the first air supply module 200, the washing liquid supply module 300), the second air supply module 200a, and the third air supply module 200b are connected to each other by pipes. As a result, the overall system may be simplified and packaged. Accordingly, assembling and repairing may be easily performed, compatibility between different types of vehicles may be increased, and costs may be reduced.

In the sensor cleaning system 10 according to an embodiment, the integrated dispenser 220 may be included in the air supply module 200, and the air pipe 214 may be configured to be connected in the air supply module 200. As a result, only the cleaning liquid pipe connection may be necessary and the air pipe connection may not be necessary between the integrated cleaning module 100 and the second air supply module 200a and between the integrated cleaning module 100 and the third air supply module 200b. Also, the sensor cleaning system 10 according to an embodiment may include an integrated dispenser 220, such that the sensor cleaning system 10 may be implemented as a single washing liquid supply module 300.

FIG. 5 is a diagram illustrating an operation in which control of an integrated dispenser is performed in a vehicle sensor cleaning system according to an embodiment.

FIG. 5 is a diagram illustrating an operation in which control of the integrated dispensers 220, 220a, and 220b is performed by the integrated control unit 500 in the vehicle V to which the sensor cleaning system 10 illustrated in FIG. 4 is applied. Hereinafter, in describing FIG. 5, FIG. 4 will also be referred to.

Referring to FIG. 5, the first integrated dispenser 220 may include a first dispenser control unit 228 and a first solenoid valve group 229. The second integrated dispenser 220a may include a second dispenser control unit 228a and a second solenoid valve group 229a. The third integrated dispenser 220b may include a third dispenser control unit 228b and a third solenoid valve group 229b. Each of the first solenoid valve group 229, the second solenoid valve group 229a, and the third solenoid valve group 229b may include a plurality of solenoid valves. The plurality of solenoid valves may include an air distribution valve for controlling the distribution of air and a cleaning liquid distribution valve for controlling the distribution of cleaning liquid. The detailed description of the substrate PCB and the plurality of solenoid valves of the integrated dispenser 220 has been described above with reference to FIGS. 1 and 2. Overlapping descriptions are not provided.

The integrated control unit 500 may apply a control signal to each of the first dispenser control unit 228, the second dispenser control unit 228a, and the third dispenser control unit 228b. Each of the first dispenser control unit 228, the second dispenser control unit 228a, and the third dispenser control unit 228b may control each of the solenoid valve groups 229, 229a, and 229b by turning the solenoid valve groups on and off based on a control signal received from the integrated control unit 500.

The integrated control unit 500 may apply a control signal for spraying air and/or cleaning liquid to at least one of the first dispenser control unit 228, the second dispenser control unit 228a, and the third dispenser control unit 228b.

When the integrated control unit 500 sends a control signal to the first dispenser control unit 228, the second dispenser control unit 228a, and the third dispenser control unit 228b, the integrated control unit 500 can activate (e.g., turn on and off) at least a portion of the plurality of solenoid valves included in the first solenoid valve group 229, the second solenoid valve group 229a, and the third solenoid valve group 229b, based on the control signal.

For example, assuming that the first integrated dispenser 220 is configured to spray air and cleaning liquid to the first sensor and the second sensor, when a control signal is applied from the integrated control unit 500 to spray air to the first sensor and to spray both air and cleaning liquid to the second sensor, the first dispenser control unit 228 may control the opening of the solenoid valve corresponding to the air spraying nozzle located at the first sensor closing of the solenoid valve corresponding to the cleaning liquid spraying nozzle located at the first sensor. Also, the first dispenser control unit 228 may control the opening of the solenoid valve corresponding to the air nozzle and cleaning liquid nozzle disposed in the second sensor.

The sensor cleaning system 10 according to an embodiment may include solenoid valve groups 229, 229a, and 229b included in the integrated dispensers 220, 220a, and 220b. The system 10 may also be configured to control the solenoid valve groups 229, 229a, and 229b included in the integrated dispensers 220, 220a, and 220b, respectively. As a result, an electrical signal connection between the integrated control unit 500 and the integrated dispensers 220, 220a, and 220b may be easily implemented.

According to the aforementioned embodiments, by integrating the air spraying system and the cleaning liquid spraying system into a module, the sensor cleaning system may be simplified and, accordingly, the system may be packaged.

Also, as the sensor cleaning system is simplified, assembling and repairing the system may be easily performed, and cost and weight may be reduced.

Also, as the sensor cleaning system is simplified, the wiring/pipe connections between modules may be reduced, thereby minimizing energy loss.

While the embodiments have been illustrated and described above, it should be apparent to those having ordinary skill in the art that modifications and variations could be made without departing from the scope of the present disclosure as defined by the appended claims.

What is claimed is:

1. An integrated cleaning module of a vehicle sensor, the integrated cleaning module comprising:
a washing liquid supply module configured to supply cleaning liquid; and
an air supply module connected to the washing liquid supply module and configured to supply air,
wherein the air supply module includes:
a compressor configured to generate compressed air;
an air tank in which the compressed air generated by the compressor is stored; and
an integrated dispenser configured to be in fluid connection with the washing liquid supply module and the air tank,
wherein the integrated dispenser is configured to distribute the cleaning liquid and the compressed air.

2. The integrated cleaning module of claim 1,
wherein the washing liquid supply module includes a cleaning liquid tank configured to store the cleaning liquid and a pump configured to transfer the cleaning liquid stored in the cleaning liquid tank to the integrated dispenser, and
wherein the integrated dispenser is configured to be in fluid connection with the pump through a pipe.

3. The integrated cleaning module of claim 2,
wherein the integrated dispenser includes an air flow path through which the compressed air supplied from the air tank moves and a cleaning liquid flow path through which the cleaning liquid supplied from the pump of the washing liquid supply module moves, and
wherein the air flow path and the cleaning liquid flow path are separated such that movement of the fluid is blocked.

4. The integrated cleaning module of claim 3,
wherein the integrated dispenser includes an air inlet port and at least one air distribution port communicating with the air flow path, and
wherein the air inlet port is connected to the air tank through a pipe.

5. The integrated cleaning module of claim 4,
wherein the integrated dispenser includes a cleaning liquid inlet port and at least one cleaning liquid distribution port communicating with the cleaning liquid flow path, and
wherein the cleaning liquid inlet port is connected to the pump through a pipe.

6. The integrated cleaning module of claim 5,
wherein the integrated dispenser includes a body in which at least one solenoid valve is disposed and an upper cover coupled to an upper portion of the body,
wherein the air flow path, the air inlet port, and the at least one air distribution port are formed on one side of the upper cover, and
wherein the cleaning liquid flow path, the cleaning liquid inlet port, and the at least one cleaning liquid distribution port are formed on another side of the upper cover.

7. The integrated cleaning module of claim 6,
wherein the at least one air distribution port includes a plurality of air distribution ports, the at least one cleaning liquid distribution port includes a plurality of cleaning liquid distribution ports, and the at least one solenoid valve includes a plurality of solenoid valves, and
wherein the plurality of solenoid valves are provided in correspondence with a number of and positions of the plurality of air distribution ports, and a number of and positions of the plurality of cleaning liquid distribution ports.

8. The integrated cleaning module of claim 1,
further comprising:
a support plate on which the air supply module and the washing liquid supply module are mounted,
wherein the air supply module and the washing liquid supply module are integrally assembled to the support plate.

9. A sensor cleaning system configured to clean a sensor of a vehicle, the sensor cleaning system comprising:
an integrated cleaning module including a washing liquid supply module configured to supply cleaning liquid and a first air supply module connected to the washing liquid supply module and configured to supply air;
a second air supply module connected to the washing liquid supply module through a first pipe; and
a third air supply module connected to the washing liquid supply module through a second pipe,
wherein the second air supply module and the third air supply module include the same components as those of the first air supply module.

10. The sensor cleaning system of claim 9, wherein the first air supply module includes:
a first compressor configured to generate compressed air;
a first air tank in which the compressed air generated by the compressor is stored; and
a first integrated dispenser connected to the washing liquid supply module and the first air tank and configured to distribute the cleaning liquid and the compressed air.

11. The sensor cleaning system of claim 10,
wherein the second air supply module includes a second compressor, a second air tank, and a second integrated dispenser,
wherein the third air supply module includes a third compressor, a third air tank, and a third integrated dispenser,
wherein the first pipe is connected to the second integrated dispenser, and
wherein the second pipe is connected to the third integrated dispenser.

12. The sensor cleaning system of claim 11,
wherein the second integrated dispenser is configured to receive the cleaning liquid from the washing liquid supply module of the integrated cleaning module through the first pipe, and
wherein the third integrated dispenser is configured to receive the cleaning liquid from the washing liquid supply module of the integrated cleaning module through the second pipe.

13. The sensor cleaning system of claim 11,
wherein the washing liquid supply module includes a cleaning liquid tank configured to store the cleaning liquid and a pump configured to move the cleaning liquid stored in the cleaning liquid tank,
wherein a first cleaning liquid discharge port and a second cleaning liquid discharge port through which the cleaning liquid is discharged are formed in the pump,
wherein the first integrated dispenser is connected to the first cleaning liquid discharge port through a pipe, and
wherein the first pipe and the second pipe are connected to the second cleaning liquid discharge port.

14. The sensor cleaning system of claim 11,
wherein each of the first integrated dispenser, the second integrated dispenser, and the third integrated dispenser includes an air inlet port and a plurality of air distribution ports,
wherein the air inlet port is connected to the air tank, and
wherein the plurality of air distribution ports are connected to a plurality of air nozzles disposed on at least one sensor and configured to spray the compressed air.

15. The sensor cleaning system of claim 14,
wherein each of the first integrated dispenser, the second integrated dispenser, and the third integrated dispenser includes a cleaning liquid inlet port and a plurality of cleaning liquid distribution ports,
wherein the cleaning liquid inlet port is connected to the washing liquid supply module, and
wherein the plurality of cleaning liquid distribution ports are connected to a plurality of cleaning liquid nozzles disposed on the at least one sensor and configured to spray the cleaning liquid.

16. The sensor cleaning system of claim 11,
wherein the first integrated dispenser, the second integrated dispenser, and the third integrated dispenser further includes a first dispenser control unit, a second dispenser control unit, and a third dispenser control unit, respectively, and
wherein the first dispenser control unit, the second dispenser control unit, and the third dispenser control unit are configured to control spraying of the compressed air and the cleaning liquid based on a control signal received from an integrated control unit of the vehicle.

17. The sensor cleaning system of claim 16,
wherein the first integrated dispenser, the second integrated dispenser, and the third integrated dispenser include a plurality of solenoid valves disposed therein, and
wherein the first dispenser control unit, the second dispenser control unit, and the third dispenser control unit are configured to control opening or closing of at least a portion of the plurality of solenoid valves based on the control signal.

18. The sensor cleaning system of claim 9, wherein the integrated cleaning module, the second air supply module, and the third air supply module are spaced apart from each other in different positions in the vehicle.
